(19) United States
(12) Patent Application Publication
(10) Pub. No.: US 2008/0195762 A1
(43) Pub. Date: Aug. 14, 2008

(54) Multifunction data entry device and method

(76) Inventor: Michael C. Wood, Ross, CA (US)

Correspondence Address: KENYON & KENYON LLP, ONE BROADWAY, NEW YORK, NY, 10004, US

(21) Appl. No.: 11/706,010

(22) Filed: Feb. 13, 2007

(51) Int. Cl. G06F 3/00

(52) U.S. Cl. 710/1

(57) ABSTRACT

A system for data entry includes a computing device and a wireless telephone or other handheld device including a handheld keyboard. The handheld keyboard is in communication with the computing device and is configured to operate as a peripheral device for text entry on the computing device.

### BACKGROUND

Computer input devices come in a myriad of forms. Some input devices are built in to the computing device, such as keypads on Automated Teller Machines (ATMs), keypads on electronic information or vending kiosks, buttons on home stereo units, keyboards on laptop computers, keypads on wireless telephones, and the like. Some input devices are external and connected to the computing device over an appropriate communications medium. For example, a conventional QWERTY keyboard for a desktop computer may be connected over a USB link or PS2 cable, or via a wireless connection. In another example, a remote control may interface with a television over a wireless connection, such as an infrared, radio frequency, or Bluetooth link. The input device provides a user the ability to interface with the computing device, including inputting commands and text data.

Many handheld devices include keyboards that are adapted to the handheld devices themselves. Some handheld devices receive user input that is sent to an internal processor to accomplish a task on the handheld device. For example, a cellular phone includes a telephone-style keypad, as well as various other keys, adapted for tasks such as sending and receiving telephone calls, inputting telephone book entries, and the like. These integrated handheld device keyboards may also be used to input text and commands, e.g., as commonly used in cell phone instant messaging. Other handheld keyboards serve as input devices for remote computing devices but do not include internal processors for tasks other than delivering the user input to the remote computing device, such as television remote controls.

Some users, particularly some younger users accustomed to cell phone instant messaging, may actually prefer the thumb keypad type interface of a cell phone to a conventional QWERTY keypad. These users may type “thumb” style text entry at surprisingly high rates of speed. Moreover, the devices allowing thumb style keypad text input, such as cellular phones, are inexpensive, highly portable, and nearly ubiquitous.

### BRIEF DESCRIPTION OF THE DRAWINGS

FIG. 1 depicts a block diagram of an example data entry system, according to an example embodiment of the present invention.

FIG. 2 depicts a block diagram of an example data entry system, according to another example embodiment of the present invention.

FIG. 3 depicts a block diagrams of an example data entry system, according to another example embodiment of the present invention.

FIGS. 4a, 4b, and 4c depict example data entry systems, according to example embodiments of the present invention.

FIG. 5 depicts an example procedure for entering data, according to an example embodiment of the present invention.

FIG. 6 depicts another example procedure for entering data, according to another example embodiment of the present invention.

### DETAILED DESCRIPTION OF EXAMPLE EMBODIMENTS

Generally, some example embodiments of the present invention allow users to employ handheld keypads or keyboards, e.g., modified versions of existing cellular telephone devices allowing “thumb” type keypad entry or dedicated handheld devices with similar interfaces, as input devices or peripherals for other systems. Some example embodiments of the present invention facilitate the user of these handheld devices as peripherals for text, data, or control entry for other electronic devices, e.g., computer systems, Internet appliances, video games, intelligent printers used in “typewriter mode”, or other non-handheld devices. This approach facilitates the use of low-cost, popular, nearly ubiquitous handheld devices as a more or less universal standard handheld peripheral device. It also allows those users who prefer the handheld device “thumb” type input approach to use their preferred input approach with other non-handheld devices.

In some of the example embodiments described herein, systems and methods may permit a handheld keyboard, as a component of either a dedicated or existing handheld device, e.g., a mobile telephone, to serve as a data entry component for both the handheld device and a separate computing device, e.g. a personal computer. In conventional operation, e.g., when not connected as an input device to a separate computing device or when operating in a user-selected stand-alone mode, the handheld device, having a handheld keyboard, such as a numeric keypad, may receive user input, e.g., “thumb” style text entry. The handheld keyboard may be operably connected to an electronic conversion component. The electronic conversion component may convert the user input to an electronic data representation and send the electronic data representation to a second data communications component via a data communications switching component. The second data communications component may send the electronic representation to a processing component. The processing component in the handheld device may manage the functionality of the handheld device (e.g., a cellular phone). Upon receiving the electronic data representation, the processing component may process the input and perform the necessary functions on the handheld device.

Alternatively, the handheld device may serve as an input device for a separate computing device, or in a “peripheral mode”. This may occur automatically if a computing device communications link exists linking the handheld device to another computing device is detected, e.g., if the handheld device is linked to another device with a USB cable or via a wireless connection. Alternatively, peripheral mode may be entered when the handheld device is instructed by a user to operate in this mode. In this mode, the data communications switching component may switch from sending the electronic data representation of the user input to the processing component in the handheld to sending it to the data communications component. (It will be appreciated that, in some implementations, the user input data may still be pre-processed by the processing component in the handheld device before it is passed via the data communications component to the separate computing device.) The data communications component may send the electronic data representation to the computing device. In this way, the handheld keyboard may serve as the data entry component for both the handheld device and the device.

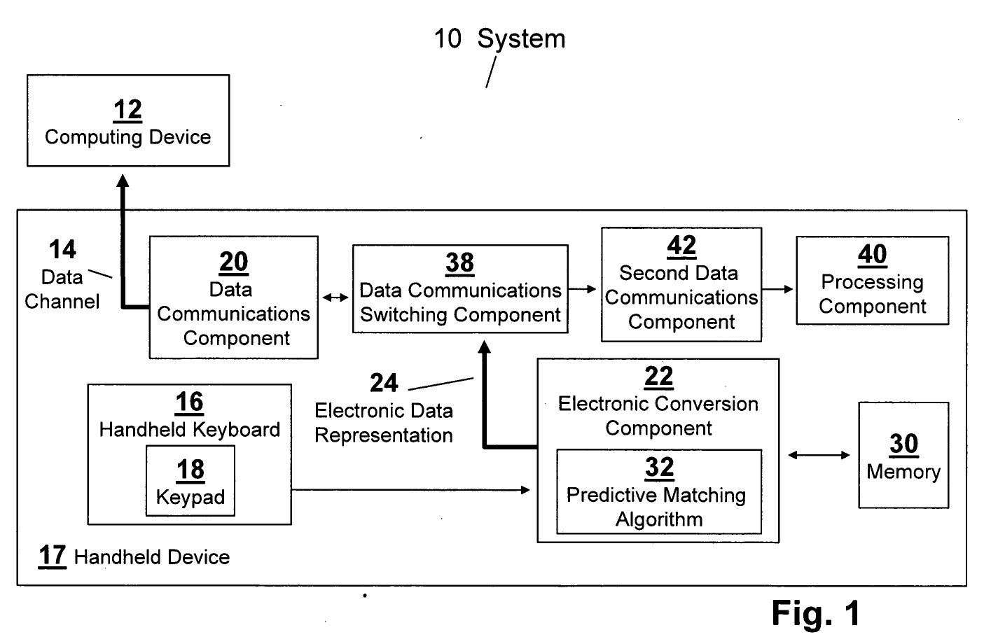

FIG. 1 depicts a block diagram of an example data entry system, according to an example embodiment of the present invention. A system 10 may include a computing device 12, handheld keyboard 16 of the handheld device 17, and data channel 14 operably connecting handheld device 17 and computing device 12. The handheld keyboard 16 may include a keypad 18. The keypad 18 may include a plurality of keys arranged to permit user input via thumb input or input by various other methods, such as by pen input, or ten finger input. The keypad 18 may receive user input from a user. The keypad 18 may be operably connected to an electronic conversion component 22. The electronic conversion component 22 may generate an electronic data representation 24 from the user input. The electronic conversion component 22 may be in communication with a memory 30 for storing data for an input data processing algorithm 32, for example a pattern matching algorithm. A data communications component 20 may receive the electronic data representation 24 and send the electronic data representation 24 to the computing device 12 via data channel 14.

A processing component 40 may manage the functions of the handheld device. The processing component 40 may include hardware and software for managing the operation of the handheld device. For example, the processing component of a GPS map device may include a processor, memory, a screen, a GPS receiver, and other input devices, such as additional keys, joysticks, and four directional arrows. The processing component may receive the electronic data representation 24 from a second data communications component 42. The data communications switching component 38 may receive the electronic data representation 24 from the electronic conversion component 22. The data communications switching component 38 may switch between sending the electronic data representation 24 to the data communications component 20 and the second data communications component 42 and vice versa, based on the existence of a communications link between the keyboard and the computing device 12.

The data communications switching component 38 may be activated to switch from one data communications component to another automatically or with user input. For example, the data communications component 20 may automatically detect whether the data channel 14 has been established between the data communications component 20 and the computing device 12. If so, the data communications component 20 may send a notification message to the data communications switching component 38. The data communications switching component 38 may then pass the electronic data representations it receives to the data communications component 20.

In this way, a handheld keyboard, which is typically used as an input device for handheld devices, may serve as an input for computing devices as well. Individuals who prefer typing on handheld keyboards or applications that lack adequate input devices may leverage the handheld keyboard to enter data on computing devices, such as kiosks, desktop computers, vending machines, ATMs, and the like.

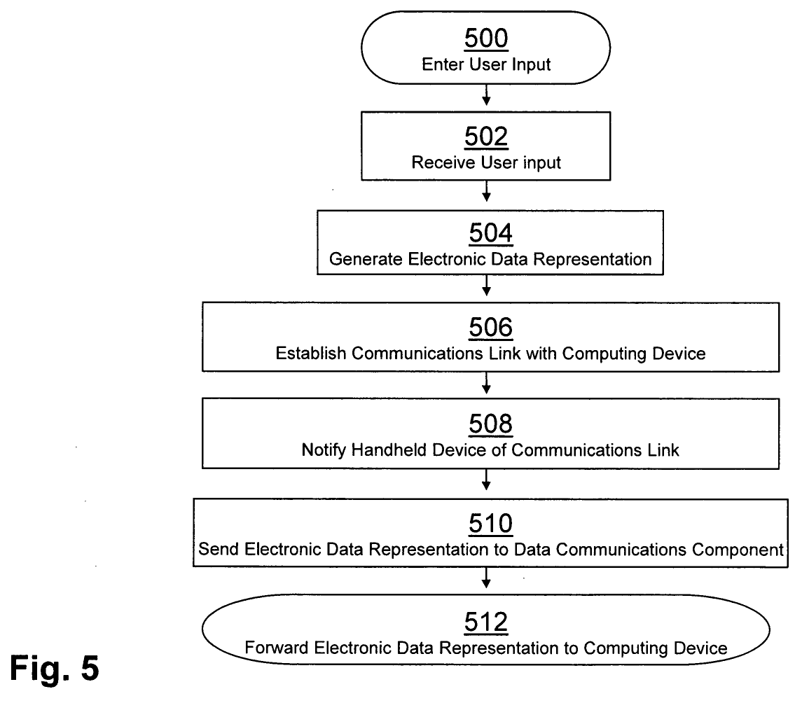

Depending on the specific implementation, keypad 18 may include varying numbers of keys in varying arrangements. In various example embodiments, the keypad 18 may include keyboards that are currently in use. For example, two configurations may exist. First, keyboards may exist in configurations such as the telephone number pad (as shown in FIG. 5a). In this configuration, the keys may be arranged in three rows of three keys, with the 1, 2, and 3 keys directly above the 4, 5, and 6 keys, and the 4, 5, and 6 keys directly above the 7, 8, and 9 keys. The entry of data on the telephone keypad may be performed using algorithms such as the T9 predictive matching algorithm (discussed below) or using other predictive matching algorithms or other entry methods. One advantage of the telephone keypad entry method may be that users can choose one-handed or two-handed input, or the users may choose to use other fingers rather than the thumbs to key in the input. The one-handed input may be especially desirable for entering data when the user's second hand is otherwise occupied, such as when holding bags or other large packages. During one-handed input, the user may grip the back or sides of the handheld keyboard and may press the keys using one thumb. Alternatively, the user may use two hands to enter data. In this case, the user may designate certain keys for entry with the left thumb and others for the right thumb. For example, the 1, 4, and 7 keys may be entered by the left hand because of proximity while the 3, 6, and 9 keys may be entered with the right thumb.

In Another example embodiment, the keypad 18 may be arranged similarly to the QWERTY-style keyboards found on various PDAs. The QWERTY-style keyboard may be a two-handed input device in which the keys are pressed by both the left and right thumbs. The remainder of the fingers may grasp the keyboard from the sides or from the back of the unit to hold the unit while the thumbs press the various keys to input data. The QWERTY-style keyboard may have various advantages. It may present a keyboard layout familiar to users of traditional desktop and laptop computers, This may reduce the amount of time users must spend learning to use the keyboard. Two-handed input also may allow users to type much more quickly than they are able to on one-handed devices. In addition, because keys exist for each of the alphabetic characters, users need not strike more than one key in order to enter one character. This presents an advantage over the telephone-style keypad in which the user may need to press two or three keys to generate a single character.

The handheld keyboard 16 may include the keypad 18 along with other user interface elements. For example, the handheld keyboard may include sliders, touch screen buttons, jog dials, and any other interface element that allows for user input.

Other arrangements and styles of handheld keyboards may be contemplated. As mobile device manufacturers develop newer keyboards, those keyboards may be used not only for the mobile devices but to input data into devices as well. The specific implementation of the arrangement of keys, unless otherwise stated, is immaterial to the forgoing discussion. Examples are provided for illustrative purposes only.

The handheld device may be any device that primarily is used by being held in the hand. Example handheld devices may include PDA's, wireless telephones, including cellular phones, GPS devices, bar code scanners, and any other devices carried in the hand that may include a processor configured to carry out computing tasks.

In one example embodiment, the computing device 12 may include computing devices that are traditionally stationary. For example, the handheld keyboard may be used to input data into desktop computers, ATMs, informational kiosks, vending machines, computers in cars (carputers), and instrument panels (e.g., in airplanes or elevators). In one example embodiment, the user may desire to withdraw money from a bank ATM. The bank may enable the user to connect his PDA to the bank's ATM (via a wired or wireless connection) to input information into the ATM. The bank may permit this alternative input method, not just to gather numeric data such as pin numbers and cash amounts, but to gather textual input as well. For example, the bank may permit the user to provide instructions to the bank when depositing a check. These instructions may include both alphabetic characters and numeric characters. For example, the user may instruct the bank “Do not clear check 000104 until Number 6, 2006.” Such input is not possible using the traditional number keypad found on ATMs currently in use. As the user presses keys on the PDA keyboard, the characters may be sent to the bank's ATM. The bank's ATM may provide feedback to the user via a display screen.

In another example embodiment, the computing device 12 may be a standalone computer, such as a desktop computer, kiosk, or the like. The standalone computer may include a processor and memory configured to perform a variety of operations. For example, the desktop computer may include running software for sending and receiving email. The user may connect the handheld keyboard (by either a wired or wireless communications link) to the desktop computer to manipulate the email program. The user may enter keystrokes into the handheld keyboard, which may be converted into electronic data representations and sent to the desktop computer. The electronic data representations may correspond to the user input. For example, if the user inputs an “a” on the handheld keyboard, the corresponding electronic representation may be the ASCII value of the letter “a” or the value 97. Alternatively, pressing keys may generate scan codes for when the keys are pressed and released (make codes and break codes). The desktop computer may interpret the electronic data representations much as scan codes received from a normal keyboard. For example, pressing the letter “a” may generate the make code 0X1c. Feedback may be provided to the user on a visual display.

In another example embodiment, the computing device 12 may be a portable device. Examples of portable devices may include laptop computers, other handheld devices, and any other portable device that may include a processor configured to carry out computing tasks.

The computing device 12 may include a keyboard for receiving user input where the handheld keyboard is not used. For example, in the above example, the keyboard may be a 101 key keyboard found with most desktop computers. The computing device may include a switching circuit for switching between the traditional keyboard and the handheld keyboard. Once a computing device determines that a handheld keyboard has been connected, the switching circuit may switch from receiving input from the traditional keyboard to the handheld keyboard via the data channel 14.

In another example embodiment, the handheld keyboard may allow a user to navigate through a series of menus for an airline arrival and departures kiosk. The user may approach the kiosk, and the handheld keyboard may automatically detect the existence of the kiosk. In one example embodiment, the user may press a key on the handheld keyboard 16 to confirm that he wishes to assume control of the kiosk with the handheld keyboard 16. The user may then use the keys of the handheld keyboard 16 to manipulate the interface for the kiosk.

The computing device 12 may include an interface for connecting the handheld keyboard 16 to the computing device 12. In one example embodiment, The interface may include hardware for detecting whether a handheld device is connected to the interface. For example, the hardware may include a USB port. The user wishing to use the handheld keyboard 16 to interface with the computing device 12 may plug the handheld keyboard 16 into the USB port directly or via a USB cable. The USB port may detect that the handheld keyboard 16 is connected and send a notification to the switching circuit (described above) that the handheld keyboard 16 has successfully connected.

In another example embodiment, the handheld keyboard 16 may connect to a printer. Text entered on the keyboard may be printed directly to the printer. For example, the handheld keyboard 16 may include a screen to indicate to the user what text has been entered and to permit the text to be edited. Text may be printed in various ways, e.g., directly, one character at a time, e.g., as in a conventional manual typewriter, in response to each letter keyed at the handheld. Text may be printed a line at a time, as lines are filled. Or, alternatively, text may be printed, after being stored on the handheld, when a print command is entered by the user. In this way, conventional printers (or computers operating as print servers) may provide a peripheral printer for a conventional wireless phone type input device. In another example embodiment, the handheld keyboard may include speech output to provide feedback. Once the text has been entered, the user may initiate a command to send the text over the appropriate communications link to the printer. Once the printer receives the text from the user, the printer may print the text. For example, the user may desire to print out the string of an instant messaging conversation to keep in his records. The user may send a command to the instant messaging software to send the conversation over a communications link. The user may choose the printer communications link and print the conversation.

In yet another example embodiment, the handheld keyboard may include a formatting component that may further include hardware or software to format the text entered by the user. For example, the handheld keyboard may include hardware and software enabling the user to download word processing, spreadsheet, presentation, diagram layout, software and the like. In another example embodiment, formatting programs may be preinstalled on the handheld keyboard 16. The user may manipulate the text to place the text in a format suitable for printing. The user may then initiate a command to send the formatted text to the printer and to print out the text.

In another example embodiment, the handheld keyboard may be connected to a plurality of computing devices. The user, when sending the text to a computing device, may select the desired computing device. The user may initiate the selection of the computing device, or the handheld keyboard may prompt the user to select the desired computing device among all computing devices within range. The data communications switching component may switch between the various connected computing devices depending on the computing device selected by the user. For example, the handheld keyboard may be within range of a laptop computer and a printer. The user may desire the handheld keyboard to control the laptop. The user may send a command to the handheld keyboard to notify it that the laptop computer is the desired computing device. The handheld computer may send a command to the data communications switching component to make the laptop communications link the active link. Thereafter, any text entered may be sent to the laptop computer. The user may then desire to send text to the printer. The user may initiate the transfer of a file. The handheld keyboard, detecting that the user is now sending a file instead of individual keystrokes, may prompt the user to select the desired computing device. The user may select the printer, and the handheld keyboard may send the file to the printer to be printed.

In another example embodiment, the interface may include a wireless interface. The wireless interface may automatically detect wireless signals sent from a wireless handheld keyboard. For example, the handheld keyboard may periodically send out a probe message to determine whether any computing devices are within range. Once the computing device 12 has been located and selected, the interface may connect with the handheld keyboard with a wireless handshake protocol. Once the connection has been established, the wireless interface may send the notification to the switching circuit.

The data channel 14 may include various data transmission media for sending the electronic data representation 24 to the computing device 12. The transmission media may include both hard-wired and wireless connections. For example, hard-wired connections may include a serial RS232 cable connection, a USB cable connection, an IEEE 1394 connection, or the like. Establishing a hard-wired connection may involve the handheld keyboard 16 being plugged into the computing device 12 via an appropriate cable. In other examples, wireless connections may include infrared connections, radio frequency connections, Bluetooth connections, or the like. Establishing a wireless connection may involve negotiating a handshake protocol to establish an open wireless channel between the handheld keyboard 16 and the computing device 12.

Once the hard-wired or wireless connection has been established, other example embodiments may involve layering additional protocols over the hard-wired or wireless connections to support the transfer of the electronic data representation 24 or other accompanying data. In one example embodiment, the handheld keyboard 16 and the computing device 12 may employ a protocol designed to ensure that each key pressed by the user is received by the computing device 12 (reliable protocol). Such a protocol may be useful in situations where interference on the connection may be high or when speed is not the primary goal of the application. For example, connection interference may be high where a wireless connection is employed, and the environment includes various wireless devices transmitting simultaneously. In another example, speed may not be the primary goal of the application. The primary goal may be that each keystroke be guaranteed to be received by the device. This may be especially useful where the user must enter data but may not be capable of verifying whether the data was completely received. For example, the user may enter buy and sell prices for various stocks while monitoring various other screens of data for the markets. The user may not tolerate any loss of data from the handheld keyboard to the computing device because it may result in a lost buy or sell opportunity. To accomplish the reliable protocol, each electronic data representation may be bundled in a packet with an accompanying sequence number. Each time an electronic data representation is received, the computing device 12 may check the sequence numbers to ensure that no sequence numbers were skipped. If a sequence number was skipped, the computing device 12 may request that the handheld keyboard 16 resend the electronic data representation having the missing sequence number. As such, the handheld keyboard 16 may include a memory for storing a series of transmitted electronic data representations in case an electronic data representation that was already sent is requested by the computing device.

In another example embodiment, the additional protocols may include cryptographic protocols designed to prevent unscrupulous observers from eavesdropping on the communications. These cryptographic protocols may encrypt the electronic data representations so that only the intended computing device may learn of the contents. The cryptographic protocols may be especially useful in wireless applications where intercepting communications is prevalent. The cryptographic protocols may include various encryption schemes, such as symmetric key cryptography, public key cryptography, PGP (pretty good privacy) cryptography, and the like. For example, a symmetric key may be exchanged between the handheld keyboard 16 and the computing device 12 during a registration phase. One exchanged, all communications between the handheld keyboard 16 and the computing device 12 may be encrypted using the symmetric key. Only the intended computing device possessing the appropriate symmetric key may decrypt the communications and read the contents therein. An example symmetric key protocol may include the DES algorithm.

In yet another example embodiment, the additional protocol may include an authentication protocol for insuring that the electronic data representations received by the computing device 12 is indeed from the intended handheld keyboard 16. For example, the authentication protocol may include a digitally signed ticket (message digest) with each electronic data representation. The computing device may verify the digital signature by performing a decryption operation and checking to see whether the contents of the ticket are valid. For example, a ticket may include a key phrase, such as “This is authentic.” The handheld keyboard 16 may digitally sign (encrypt) the ticket using its own private key. The computing device may obtain the public key of the handheld keyboard 16 and decrypt the ticket. In one example embodiment, if the decrypted ticket includes the phrase “This is authentic,” then the electronic data representation may be valid. The use of public key cryptography may be most useful where the speed of entering data is not the most important goal of the application. This is because public key cryptography may be processor intensive. In another example embodiment, the digital signature may be accomplished using symmetric key cryptography. Only the entity possessing the appropriate symmetric key may decrypt the signed digest. Therefore, if the computing device is able to decrypt the digest, and the digest includes the appropriate message, the computing device may determine that the handheld keyboard is authentic.

The electronic conversion component 22 may include a processor for converting the user input into its corresponding digital representation. The processor may include input signal lines connected to the output lines for the keypad 18. The keypad 18 may send the key codes over the input lines to the processor. The processor may convert the key codes into an appropriate electronic data representation for transmission to the computing device 12. The specific implementation of the processor, unless stated, is immaterial to the forgoing description.

The processor of the electronic conversion component 22 may run conversion routines to convert the user input received from the keypad 18 into an appropriate electronic data representation 24. For example, the keypad 18 may include a QWERTY-style keypad. The QWERTY-style keypad may send make and break codes each time that a key is pressed and released respectively. The electronic conversion component 22 may convert the make and break codes into an internal representation of the letters, numbers, and symbols pressed by the user. For example, the electronic conversion component 22 may receive a make code for a shift key and an “A” key before receiving the corresponding break codes for the shift and “a” keys. The electronic conversion component 22 may interpret this key combination as an upper case “A”. The electronic conversion component 22 may include a mapping table that maps the user input to the corresponding data representations. For example, the electronic conversion component 22 may be configured to transmit electronic data representations to the computing device 12 in the form of ASCII codes the mapping table may include an entry which maps the combination of make codes for the shift and “a” keys into the ASCII value 65. The electronic conversion component 22 may output the electronic data representation of the shift and “a” key combination as the value 65.

In another example embodiment, the electronic conversion component 22 may include routines to convert the user input by applying input preprocessing algorithms, such as the T-9 data entry algorithm. For example, the keypad 18 may include a telephone-style keypad, with the numbers 1-9 arranged in a three by three grid. Each character of input may include one or more key presses. When the user presses a particular key, the algorithm may interpret the next key to be a subselection of the letters associated with that key. For example, the “2” key on the traditional keypad may correspond to the letters “a,” “b,” and “c”. The user may enter “2” “2” in order to select the letter “b”. A 7 key may be associated with the letters “p”, “r”, and “s”. The letter “s” may be keyed in with the key combination “7” “3”. The electronic conversion component 22 may include a mapping table that maps the input “2” “2” to the letter “b”. Other keys other than 1-9 keys may allow for greater numbers of characters to be entered. For example, if a “#” key exists, pressing the “#” key may allow the user to enter any number from 1-9 by following up with that number. In this example, the electronic conversion component 22 may map the user input “#” “6” to be the number 6.

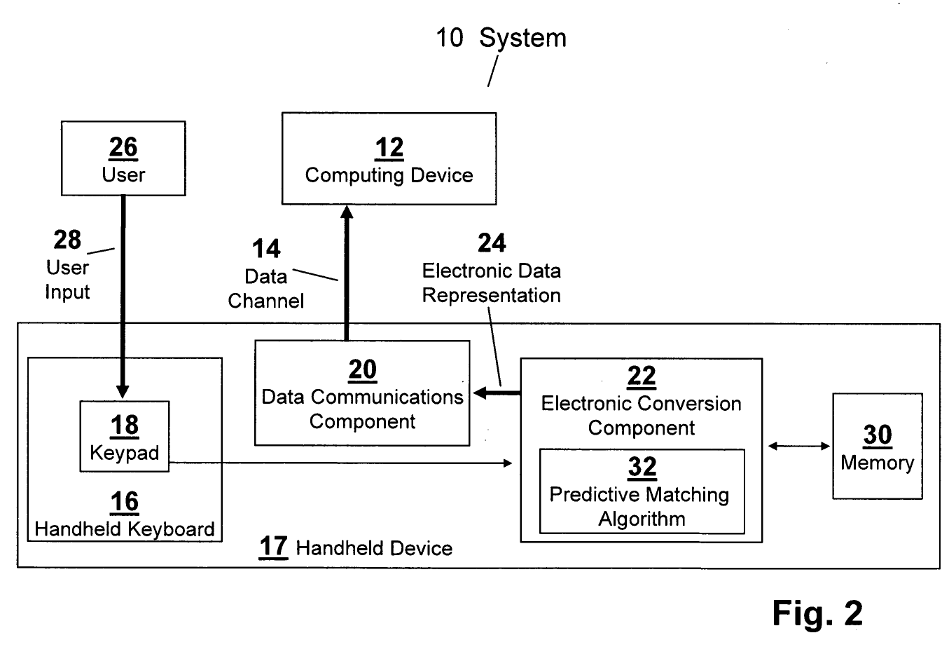

In another example embodiment, (as shown in FIG. 2) the electronic conversion component 22 may include routines and data for performing a predictive matching algorithm on the user input 28. A predictive matching algorithm 32 may attempt to guess the remainder of a word or phrase before the word or phrase is completely entered by the user 26. The electronic conversion component 22 may receive algorithm data from memory 30, used to store a set of commonly used words or phrases. As the electronic conversion component 22 receives user input 28, it may attempt to match the user input with words or phrases in the memory 30. For example, the memory 30 may include the words “the” and “this.” The electronic conversion component may receive the user input that corresponds to the letter “t”. The electronic conversion component 22 may look up words in the memory 30 and choose the first word that begins with “t”. In this example, “the” may be returned. The electronic conversion component may send the word “the” to be displayed on a display viewed by the user 26. The user may select the word “the” by pressing the key combination equivalent to the space key. Alternatively, the user 26 may enter the letters “hi.” The electronic conversion component 22 may attempt to match the entire input “thi” with words or phrases in the memory 30. The word “this” may be returned and displayed to the user. The user may then input the space character to select the word “this.” In this way, the user 26 may enter data more rapidly because the user need not type the entire word or phrase for commonly used words and phrases.

In another example embodiment, the predictive matching algorithm may learn what words are the most common to a particular user based on the first letters entered. For example, if the user commonly uses the word “apple,” the algorithm may display the word “apple” when the user types in the characters “ap.” If the user begins to use the word “approximately” more frequently than “apple,” the algorithm may prioritize “approximately” above “apple” and display “approximately” to the user upon receiving the input “ap.”

Returning to FIG. 1, in yet another example embodiment, the conversion component may be configured to convert the user input from one format to another format based on a conversion algorithm. For example, the user may input the user input in short hand format, such as may be used by court stenographers. The conversion component may translate the short hand into full text. The conversion component may include various translation rules that may match short hand and replace the short hand with full text. In one example, a translation rule may convert the input “I c u” into the words “I see you.” Other conversion components may include spell checking components, grammar checking components, and the like.

The electronic conversion component 22 may be configured to include mappings to the electronic data representations required by the particular computing device. Various computing devices 12 may require various electronic data representations for the same character or words. For example, the handheld keyboard may include routines to communicate with desktop computers and proprietary instrument panels, such as those found in airplanes. The desktop computers may require input in PS2 protocol format or may require ASCII character values. The airplane instrument panel may require a proprietary character set because it may include buttons not found on traditional keyboards. The electronic conversion component may include mapping tables that map from the user input to the PS2 scan codes, ASCII character codes, and proprietary codes for the airplane instrument panel. A second mapping table may map from the particular type of computing device (e.g., a desktop computer or an airplane instrument panel) to the set of character codes to use. In one example embodiment, The electronic conversion component 22 may include a switching routine or circuit that senses the particular computing device being used and switches the mapping table used by the electronic conversion component 22. Each time that the handheld keyboard 16 is connected to a computing device 12, the switching circuit may receive an indication of what electronic data representations are to be used. In one example embodiment, this indication may be in the form of data sent from the computing device 12 during a set-up, handshaking protocol. In another example embodiment, the electronic conversion component 22 may include a table of computing devices and their corresponding electronic data representations. This table may be consulted each time that a new computing device is connected.

The data communications component 20 may handle aspects of communicating with the computing device 22. The data communications component 20 may handle set-up of, maintenance of, transmission across, and tear down of the data channel 14 between the handheld keyboard 16 and the computing device 12. During set-up, various aspects of the data channel 14 may be established, including the type of electronic data representations required, the data communications protocol, what type of security protocols should be used, and the like. For example, the computing device 12 may transmit a string or code indicating which electronic data representation it requires from the electronic conversion component 22. For example, the string may indicate that the PS2 codes are to be sent. In another example embodiment, the handheld keyboard 16 and the computing device 12 may agree on the data communications protocol to be used to transmit the electronic data representations. For example, the handheld keyboard may include functions to send electronic data representations 24 using TCP, Bluetooth, and UDP. The computing device 12 may be capable of using TCP and UDP only. The data communications component 20 and the computing device 12 may send their respective supported protocols to the other unit. Each unit may include a prioritized, common list of communications protocols. For example, the TCP protocol may be the highest ranked protocol. The units may select the commonly supported protocol with the highest priority, which may be the TCP protocol.

In another example embodiment, the data communications component 20 and the computing device 12 may determine whether a secure connection is required. If so, they may exchange the necessary information to establish the secure connection. The necessary information may include secret keys, the security protocols to be used, and authenticating information to authenticate the handheld keyboard 16 to the computing device 12 and vice versa. For example, the data communications component 20 may send a query to the computing device 12 to inquire whether a secure connection is required or possible. The computing device 12 may reply with the secure protocols it supports, such as symmetric key cryptography. The handheld keyboard may reply that symmetric key cryptography is to be used. In another example, the computing device 12 may attempt to authenticate the handheld keyboard 16. To do so, the computing device may send a challenge. The data communications component 20 may process the challenge and reply with a response and a challenge of its own. The computing device 12 may respond with a response to the challenge from the data communications component 20. Once both responses are verified, the units may agree on a symmetric key to be used. Each device may include a list of various keys. These keys may have been exchanged in a secure manner during a registration step. The handheld keyboard may send a command to use a particular key, such as the first key. At that point, the data communications component 20 and the computing device 12 may encrypt all future communications using the symmetric key.

The data communications component 20 may maintain the data channel 14. Maintenance may involve keeping the connection alive, maintaining the secure connection, and the like. For example, to prevent unscrupulous individuals from hijacking a data channel, the computing device 12 may terminate any data channel that has been idle (i.e., no data has been transmitted over it) for a particular time period. The data communications component 20 may maintain the data channel by periodically sending out a heartbeat message to keep the computing device 12 from terminating the data channel. In another example, the data communications component 20 may periodically alter the symmetric key used. The data communications component 20 may transmit a reference to the new key. The units may then switch to using the new key.

Alternatively, the data communications component may manage the transmission of data. In various example embodiments, this may involve placing any necessary metadata on the electronic data representations 24, retransmitting lost data, etc. In one embodiment, the data communications component 20 may manage the transmission of data in a wireless network. The data communications component 20 may detect data collisions and retransmit accordingly, such as after an appropriate back-off. The transmission of electronic data representations may also involve transmitting over the particular protocols to be used.

In yet another example embodiment, the data communications component 20 may manage tear-down of the data channel 14. Tear-down may involve sending a terminating message to the computing device.

In one example embodiment, the user may be notified once the handheld keyboard 16 has successfully connected with the computing device 12. Once the data communications component 20 has established the data channel 14, an alert may be sent to the handheld keyboard 16 or to the computing device 12. For example, the handheld keyboard 16 may receive the alert and alert the user, for example, by vibrating, emitting an audible tone, playing back a prerecorded audio segment, flashing a light, displaying a message on the connected display, or the like to notify the user that the handheld keyboard 16 is connected. The user may then know that the user input will be sent to the computing device 12. In another example, the alert may be sent to the computing device 12. The computing device 12 may alert the user by vibrating, emitting an audible tone, playing back a prerecorded audio segment, flashing a light, displaying a message on the connected display, or the like.

In yet another embodiment, the handheld keyboard 16 may automatically scan to see if a computing device is available for connection. This may be especially useful where the connection is a wireless connection. The computing device may periodically send out a signal informing other devices that it exists for connection. Alternatively, the handheld keyboard may send out a signal to see whether there are appropriate computing devices available. For example, in handheld keyboard active mode, the handheld keyboard 16 may send a probe message over the air. All computing devices within range may respond. The response may include the type and name of the computing device, supported protocols, whether encryption is required, channels supported by the computing devices, and the like. The handheld keyboard 16 may display the names of the computing devices within range to the user. The user may select the desired device from the list. Alternatively, the handheld keyboard may listen to transmissions from the computing devices within range. The user may select from among the available computing devices and connect to the one selected

In another example embodiment, the user may activate the data communications switching component 38 to switch from one data communications component to another. For example, the user may be presented with an alert that a computing device 12 is available to receive user input. The user may be prompted with a question of whether he wishes to connect to the computing device. The user may choose “yes.” In response, a signal may be sent to the data communications switching component 38. The data communications switching component 38 may then switch to sending the electronic data representations to the data communications component 20.

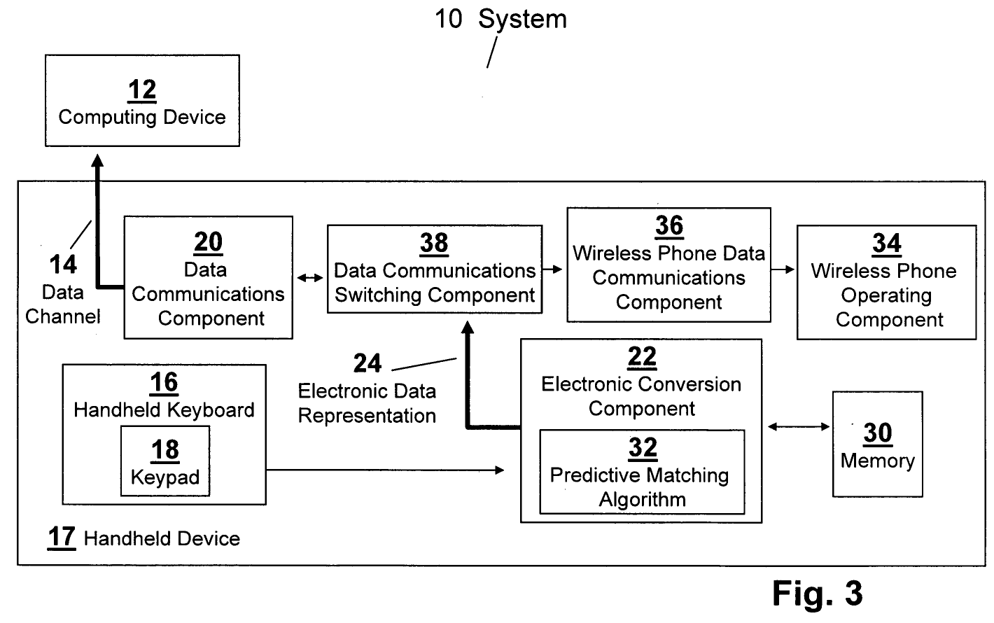

FIG. 3 depicts a block diagram of an example data entry system, according to yet another example embodiment of the present invention. The handheld keyboard 16 may be in communication with a wireless telephone operating component 34. The wireless telephone operating component 34 may manage the functions associated with a wireless telephone, such as a cellular phone, satellite phone, cordless phone, or the like. A wireless telephone data communications component 36 may be in communication with the wireless telephone operating component 34. A data communications switching component 38 may receive the electronic data representation 24 from the electronic conversion component 22. The data communications switching component 38 may switch between sending the electronic data representation 24 to the data communications component 20 to sending it to the wireless telephone data communications component 36. If the data communications component 20 receives the electronic data representation 24, it may send the electronic data representation 24 to the device 12. If the wireless telephone data communications component 36 receives the electronic data representation 24, it may send the electronic data representation 24 to the wireless telephone operating component 34. In this way, the user may use the handheld keyboard 16 to operate the wireless telephone or to send the data to a computing device 12, depending on the specific needs of the application.

The wireless telephone operating component 34 may include the hardware and software needed to operate a wireless telephone. For example, the hardware may include a processor for managing the operation of the wireless telephone, a memory for storing data such as phone books, operating system code, and the like, a screen for displaying feedback to the user, a microphone, a speaker, and a radio transceiver for sending and receiving the wireless calls. In other example embodiments, the wireless telephone operating component may include a global positioning system (GPS) for determining the exact location of the device. The GPS may include hardware, such as a processor and antenna, and software for calculating the position from satellite data. In other embodiments, the GPS may include a display for displaying maps of the location of the wireless telephone. In practice, the specific implementation of the wireless telephone operating component 34, unless specified, is immaterial to the forgoing description.

In another example embodiment, the electronic data representation may include multiple characters. The electronic data representation 24 may include multiple characters of user input. For example, the protocol for sending electronic data representation 24 to computing device 12 may specify that multiple character codes may be sent in a single transmission if those characters are separated by a delimiter. The electronic conversion component may receive several characters of user input and convert them to the electronic data representation by inserting the delimiter between the character codes. For example, where every character code is represented by an eight-bit value, from 00000001 to 11111111, the delimiter may be eight bits of 0s. In this way, the speed of sending the user input to the computing device 12 may be increased.

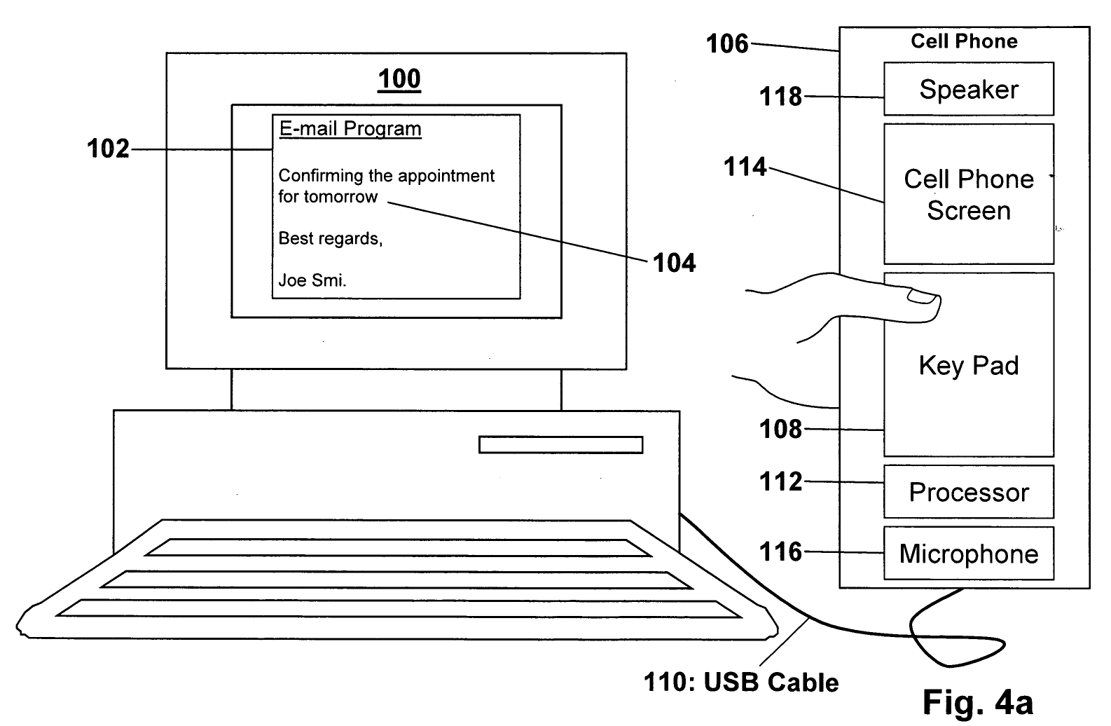

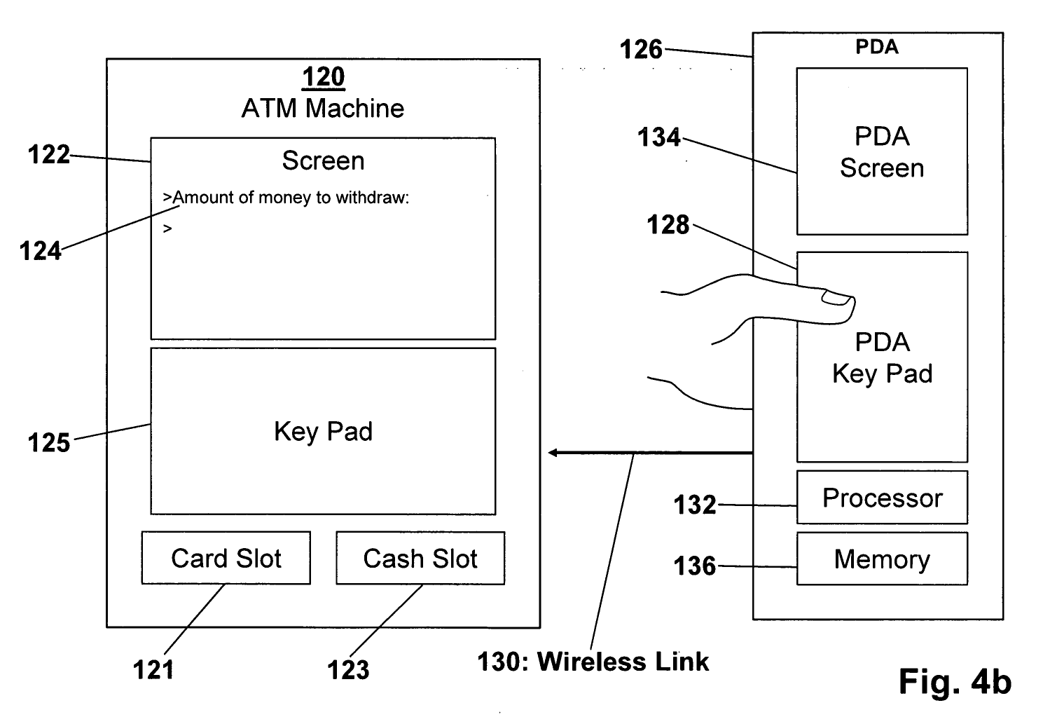

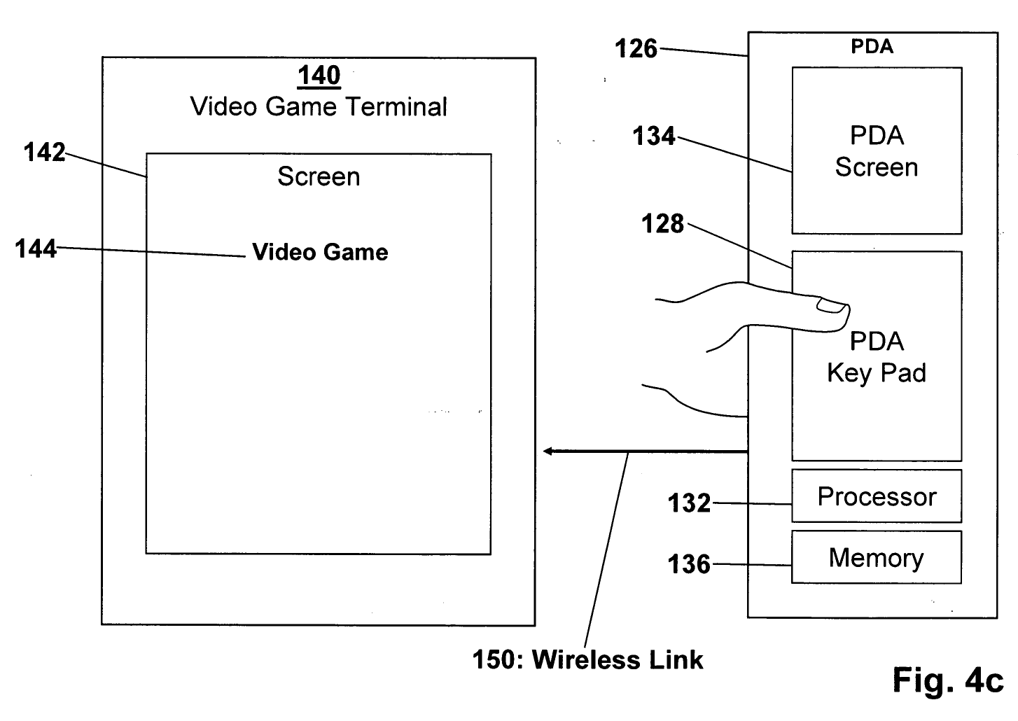

FIGS. 4a, 4b, and 4c depict example data entry systems, according to example embodiments of the present invention. Turning to FIG. 4a, an example system is depicted showing the entry of data into an email program 102 running on a desktop computer 100. The user may press cell phone keys pad 108 on a cellular phone 106. The cellular phone 106 may be in communication with the desktop computer 100, including a display screen. The communications link may include a USB cable 110. The cellular phone 106 may include a processor 112, a screen 114, a microphone 116, and a speaker 118.

In this example, the cellular phone 106 may include the functionality of a typical cellular phone—placing and receiving calls, maintaining a phone book, etc. As such, the cell phone keypad 108 may be used to enter data to be processed by the cellular phone 106.

In addition, the keys 108 may be redirected to be transmitted over USB cable 110 to the desktop computer 100. Once the cellular phone 106 detects the existence of a communications link to a desktop computer 100, the cellular phone 106 may switch to sending the user input to the desktop computer 100 via the USB cable 110. For example, when the USB cable 110 is inserted into a USB port on the desktop computer 100, the desktop computer 100 may send a signal to the cellular phone 106 notifying the cellular phone 106 that it is connected. A data communications switching component (not shown) may receive the notification. The data communications switching component may be in communication with the desktop computer 100 via the USB cable 110. The data communications switching component may then redirect electronic data representations to the USB cable 110 instead of sending them to the cellular phone 106.

The user may enter text 104. The data communications switching component may send the resulting electronic data representation of text 104 to the desktop computer 100. Once the desktop computer 100 receives the text, it may pass the text to the email program 102. The email program 102 may display the text on the screen. The user may complete the email on the screen and send the email, using the keyboard of the cellular phone 106.

Once the user has completed the email, the user may disconnect the cellular phone 106 from the desktop computer 100. Disconnecting the USB cable 110 may generate a signal to the data communications switching component that the connection to the desktop 100 has been terminated. The data communications switching component may then automatically redirect the electronic data representations back to the cellular phone 106. This may activate normal operation of the cellular phone 106, and the user may resume using the cellular phone 106 with the keyboard 108.

FIG. 4b depicts an example data entry system, according to another example embodiment of the present invention. A PDA 126 may include a PDA keypad 128, processor 132, screen 134, and memory 136. The PDA 126 may include a wireless link 110 connecting the PDA 126 to a bank ATM machine 120. The bank ATM machine 120 may include a screen 122 for providing user feedback. The screen 122 may include a prompt 124 requesting input from the user—for example, asking for the amount of money to withdraw. A card slot 121 may allow a user to insert his bank card. A cash slot 123 may dispense cash. A keypad 125 may be used for traditional user input.

In this example, PDA 120 may include the functions of a typical PDA. For example, memory 136 may include programs for sending and receiving electronic mail; browsing the Web; maintaining a calendar; editing word processing documents, presentations, and spread sheets; displaying photos; playing music; navigating maps using GPS; and the like. The screen 134 may display feedback to the user, and the PDA keypad 128 may accept user input.

The bank ATM 120 may include the hardware and software for a typical bank ATM. For example, it may allow the user to deposit checks and withdraw money. The bank ATM 120 may also permit the user to make transactions in brokerage accounts, purchase stamps, and leave feedback for the bank.

The PDA 126 may serve as the data entry system for the bank ATM by connecting to the bank ATM 120 over a wireless link 130. Either the bank ATM 120 or the PDA 126 may send a wireless probe message. Upon receiving the probe message, the recipient may respond to inform the sender that the recipient is within range. For example, the bank ATM 120 may periodically send a probe message. The PDA 126 may detect the existence of the bank ATM 120 by receiving the probe message and may attempt to connect to it.

The PDA 126 and the bank ATM 120 may negotiate parameters for the wireless link by executing a handshake protocol. For example, the handshake protocol may establish security parameters, transmission rates, transmission frequency, and perform authentication (described above). Once the wireless link 130 has been established, a data communications switching component (not shown) may receive a notification that the PDA has been connected to the bank ATM 120. The data communications switching component may redirect any electronic data representations to the bank ATM 120.

FIG. 4c depicts an example data entry system, according to another example embodiment of the present invention. A PDA 126 may serve as the game controller for a video game terminal 140. The video game terminal may be connected to a screen 142 showing a game screen 144. For example, the screen 142 may include a television set. The PDA 126 and video game terminal 140 may be connected via a wireless link 150. User input via the PDA keypad 128 may be sent over the wireless link 150 and used to control the video game terminal 140.

FIG. 5 depicts an example procedure for entering data, according to an example embodiment of the present invention. A user may desire to interact with a computing device by entering user input into a handheld keyboard. For example, the user may wish to type n email on a desktop computer using his cellular phone or PDA. The user may enter user input (block 500) into the handheld keyboard. The handheld keyboard may include keyboards traditionally found on handheld devices, such as a cellular phone, PDA, or Blackberry. The handheld keyboard may include a key layout suitable for one-handed or two-handed input. An electronic conversion component may receive the input (block 502) and generate an electronic data representation for the user input (block 504). In generating the electronic data representation, the electronic conversion component may map the user input to the electronic data representation using a mapping table. For example, the mapping table may include an entry that maps the scan code for the letter “a”, (e.g., code 0X1c) into the ASCII value of the letter “a” (ASCII value 97). The electronic conversion component may include various mapping tables. The electronic conversion component may select between the mapping table based on the computing device that the handheld keyboard is connected to.

The handheld keyboard may establish a computing device communications link between the handheld keyboard and the computing device (block 506). The computing device communications link may include hard-wired and wireless links, for example, USB, RS232 serial, IEEE 1394, infrared, radio frequency, or Bluetooth. As described above, handshake protocols may be executed to establish the parameters for the connection. For example, parameters may include security parameters, transmission rates, transmission frequency, and authenticating information. Once the computing device communications link is established, a notification may be sent to the handheld keyboard (block 508). The user may in turn be alerted to the fact that the handheld keyboard is connected to the computing device and that future input will be routed to the computing device.

The electronic conversion component may send the electronic data representation to a data communications component (block 510). The data communications component may forward the electronic data representation over the computing device communications link to the computing device (block 512). The data communications component may transmit the electronic data representation using the appropriate communications protocols defined for the computing device communications link. For example, the computing device communications link may require that the electronic data representations be enclosed in a packet with a header. The header may include a sequence number that may be tracked for retransmission purposes. The transmission protocol may include the TCP protocol for guaranteeing the delivery of electronic data representations.

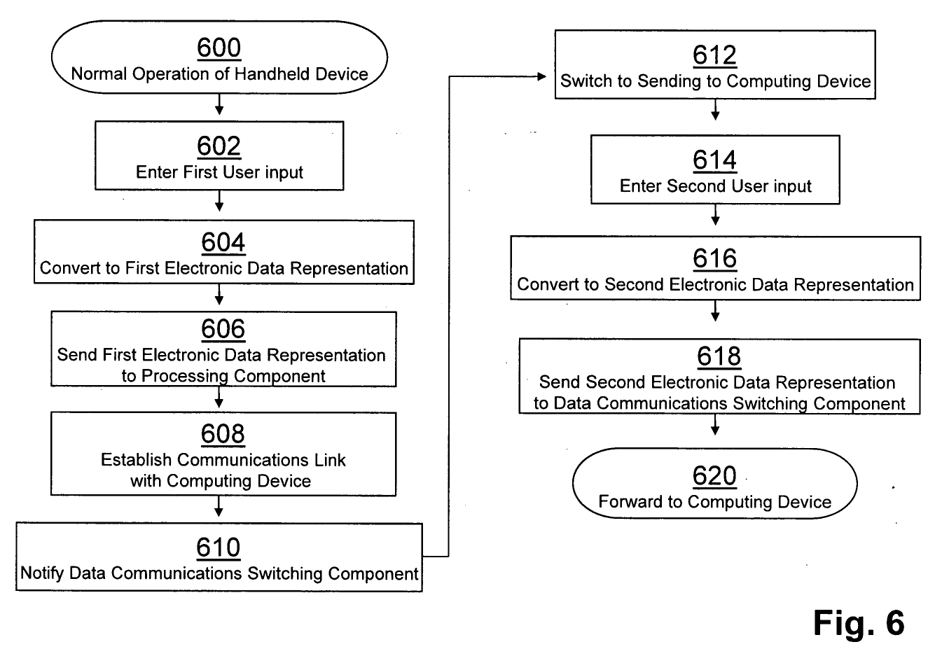

FIG. 6 depicts another example procedure for entering data, according to another example embodiment of the present invention. A user may operate a handheld device, such as a cell phone, PDA, or the like, in normal operation (block 600). Normal operation may include the typical functions of the handheld device. For example, the user may place a telephone call using a cellular phone or navigate across a map on a GPS receiver. The user may press keys on a keyboard to operate the handheld device. The keys on the keyboard may be arranged in an optimal manner for thumb input or may be arranged for input with various fingers. The user may enter a first user input into the keyboard (block 602). The electronic conversion component may convert the first user input into a first electronic data representation (block 604). The conversion may involve mapping the user input to the electronic data representation using a mapping table. The electronic conversion component may send the first electronic data representation t6 a processing component via a data communications switching component (block 606). The processing component may be responsible for managing and executing the normal functionality of the handheld device. The processing component may include hardware and software for normal operation of the handheld device. For example, the processing component of a PDA may include a processor, screen, memory, and software to be run on the processor.

The keyboard may establish a computing device communications link with a computing device (block 608) as described above. Once the computing device communications link has been established, a notification may be sent to the data communications switching component (block 610). Thereafter, the data communications switching component may switch from forwarding data, not to the processing component but to the device (block 612).

The electronic conversion component may receive a second user input (block 614) and convert it into a second electronic data representation (block 616). The electronic conversion component may send the second electronic data representation to the data communications switching component (block 618), and the data communications switching component may forward the data to the device via a data communications component (block 620). The data communications component may execute the necessary protocols to send the second electronic data representation over the computing device communications link. In this way, the user may switch from inputting data into the handheld device to inputting data into the computing device with the same keyboard.

One example embodiment of the present invention includes a system for data entry for a computing device. The system may include a handheld device including a handheld keyboard and a processing component, the handheld keyboard having a plurality of keys and configured to receive user input and to serve as a peripheral device for the computing device, the processing component configured to perform computing tasks. The system may further include an electronic conversion component configured to convert the user input into an electronic representation. The system may further include a first data communications component configured to send the electronic data representation to the computing device. The system may further include a second data communications component configured to send the electronic data representation to the processing component. The system may also include a data communications switching component configured to receive the electronic data representation and further configured to switch from sending the electronic data representation to the second data communications component to sending the electronic data representation to the first data communications component based on the existence of a computing device communications link, wherein the first and second data communications components are configured to receive the electronic data representation from the electronic conversion component via the data communications switching component. In the system, the computing device may be, e.g., a desktop computer, bank ATM, carputer, printer, or electronic kiosk.

Another example embodiment of the present invention may include a system for data entry. The system may include a computing device and a handheld device with a handheld keyboard, the handheld keyboard configured to facilitate thumb text entry, the handheld keyboard in communication with the computing device and configured to operate as a peripheral device providing user text entry on the computing device.

Another example embodiment of the present invention may include a system for data entry. The system may include a computing device and a wireless telephone including a handheld keyboard, the handheld keyboard in communication with the computing device and configured to operate as a peripheral device providing user text entry on the computing device.

Another example embodiment of the present invention may include a system for data entry to a computing device. The system may include a wireless telephone including a handheld keyboard and a wireless telephone operating component, the keyboard configured to receive user input and the wireless telephone operating component configured to send and receive telephone calls, the keyboard further configured to serve a peripheral device for the computing device. The system may also include an electronic conversion component configured to convert the user input into an electronic representation. The system may also include a data communications component configured to send the electronic data representation to the computing device. The system may also include a wireless telephone data communications component configured to send the electronic data representation to the wireless telephone operating component. The system may also include a data communications switching component configured to receive the electronic data representation and further configured to switch from sending the electronic data representation to the wireless telephone data communications component to sending the electronic data representation to the data communications component based on the existence of a computing device communications link, wherein the data communications component is configured to receive the electronic data representation from the electronic conversion component via the data communications switching component, and wherein the wireless telephone data communications component is configured to receive the electronic data representation from the electronic conversion component via the data communications switching component.

Another example embodiment of the present invention may include a method of data entry for a computing device. The method may include receiving user input from a handheld keyboard of a wireless telephone, generating an electronic data representation of the user input, processing the electronic data representation at the wireless telephone, detecting the existence of a computing device communications link, responsive to detecting the existence of the computing device communications link, configuring the handheld keyboard to serve as a peripheral of the computing device, and sending the electronic data representation to a computing device over the computing device communications link.

Another example embodiment of the present invention may include a method of data entry for a computing device. The method may include receiving user input from a handheld keyboard of a handheld computing device, the handheld keyboard including a plurality of keys, generating an electronic data representation of the user input; processing the electronic data representation at the handheld computing device, detecting the existence of a computing device communications link, responsive to detecting the existence of the computing device communications link, configuring the handheld keyboard to serve as a peripheral of the computing device and sending the electronic data representation to a computing device over the computing device communications link.

It will be appreciated that all of the disclosed methods and procedures described herein can be implemented using one or more computer programs or components. These components may be provided as a series of computer instructions on any conventional computer readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

In the preceding specification, the description has been provided with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

What is claimed is:

1. A system for data entry for a computing device, comprising:
a handheld device including a handheld keyboard and a processing component, the handheld keyboard having a plurality of keys and configured to receive user input and to serve as a peripheral device for the computing device, the processing component configured to perform computing tasks;
an electronic conversion component configured to convert the user input into an electronic representation;
a first data communications component configured to send the electronic data representation to the computing device;
a second data communications component configured to send the electronic data representation to the processing component; and
a data communications switching component configured to receive the electronic data representation and further configured to switch from sending the electronic data representation to the second data communications component to sending the electronic data representation to the first data communications component based on the existence of a computing device communications link,
wherein the first and second data communications components are configured to receive the electronic data representation from the electronic conversion component via the data communications switching component.

2. The system of claim 1, wherein the computing device is a desktop computer.

3. The system of claim 1, wherein the computing device is a bank ATM.

4. The system of claim 1, wherein the computing device is a carputer.

5. The system of claim 1, wherein the computing device is a printer.

6. The system of claim 1, wherein the computing device is an electronic kiosk.

7. The system of claim 1, wherein the electronic conversion component is configured to generate the electronic data representation according to a predictive matching data entry algorithm.

8. The system of claim 7, further comprising:
a memory on the handheld device configured to store predictive terms for the predictive matching data entry algorithm.

9. The system of claim 1, wherein the first data communications component is configured to send the electronic data representation over a USB link toward the computing device.

10. The system of claim 1, wherein the first data communications component is configured to send the electronic data representation over a Bluetooth link.

11. The system of claim 1, wherein the first data communications component is configured to send the electronic data representation over an infrared link.

12. The system of claim 1, wherein the first data communications component is configured to send the electronic data representation over a radio frequency link.

13. The system of claim 1, wherein the first data communications component is configured to cryptographically secure the electronic data representation with a cryptographic protocol.

14. The system of claim 13, wherein the cryptographic protocol is symmetric key cryptography.

15. The system of claim 1, wherein the input device further includes a reduced-sized QWERTY keyboard.

16. The system of claim 1, wherein the plurality of keys is arranged as a calculator-style numeric keypad.

17. The system of claim 1, further comprising:
a formatting component configured to format the electronic data representation.

18. The system of claim 1, further comprising:
a translation component configured to convert shorthand codes into full text.

19. A system for data entry comprising:
a computing device;
a handheld device with a handheld keyboard, the handheld keyboard configured to facilitate thumb text entry, the handheld keyboard in communication with the computing device and configured to operate as a peripheral device providing user text entry on the computing device.

20. A system for data entry comprising:
a computing device; and
a wireless telephone including a handheld keyboard, the handheld keyboard in communication with the computing device and configured to operate as a peripheral device providing user text entry on the computing device.

21. A system for data entry to a computing device, comprising:
a wireless telephone including a handheld keyboard and a wireless telephone operating component, the keyboard configured to receive user input and the wireless telephone operating component configured to send and receive telephone calls, the keyboard further configured to serve a peripheral device for the computing device;
an electronic conversion component configured to convert the user input into an electronic representation;
a data communications component configured to send the electronic data representation to the computing device;
a wireless telephone data communications component configured to send the electronic data representation to the wireless telephone operating component; and
a data communications switching component configured to receive the electronic data representation and further configured to switch from sending the electronic data representation to the wireless telephone data communications component to sending the electronic data representation to the data communications component based on the existence of a computing device communications link,
wherein the data communications component is configured to receive the electronic data representation from the electronic conversion component via the data communications switching component,
wherein the wireless telephone data communications component is configured to receive the electronic data representation from the electronic conversion component via the data communications switching component.

22. A method of data entry for a computing device, comprising:
receiving user input from a handheld keyboard of a wireless telephone;
generating an electronic data representation of the user input;
processing the electronic data representation at the wireless telephone;
detecting the existence of a computing device communications link;
responsive to detecting the existence of the computing device communications link, configuring the handheld keyboard to serve as a peripheral of the computing device; and
sending the electronic data representation to a computing device over the computing device communications link.

23. A method of data entry for a computing device, comprising:
receiving user input from a handheld keyboard of a handheld computing device, the handheld keyboard including a plurality of keys;
generating an electronic data representation of the user input; processing the electronic data representation at the handheld computing device;
detecting the existence of a computing device communications link;
responsive to detecting the existence of the computing device communications link, configuring the handheld keyboard to serve as a peripheral of the computing device and sending the electronic data representation to a computing device over the computing device communications link.

24. The method of claim 23, further comprising:
sending the electronic data representation to a desktop computer.

25. The method of claim 23, further comprising:
sending the electronic data representation to a bank ATM.

26. The method of claim 23, further comprising:
sending the electronic data representation to a carputer.

27. The method of claim 23, further comprising:
sending the electronic data representation to a printer.

28. The method of claim 23, further comprising:
sending the electronic data representation to an electronic kiosk.

29. The method of claim 23, further comprising:
generating the electronic data representation according to a predictive matching data entry algorithm.

30. The method of claim 29, further comprising:
storing predictive terms for the predictive matching data entry algorithm.

31. The method of claim 23, further comprising:
sending the electronic data representation over a USB link.

32. The method of claim 23, further comprising:
sending the electronic data representation over a Bluetooth link.

33. The method of claim 23, further comprising:
sending the electronic data representation over an infrared link.

34. The method of claim 23, further comprising:
sending the electronic data representation over a radio frequency link.

35. The method of claim 23, further comprising:
sending the electronic data representation over a cryptographically secure link.

36. The method of claim 35, wherein the cryptographically secure link is secured using symmetric key cryptography.

37. The method of claim 23, wherein the handheld keyboard further includes a reduced-sized QWERTY keyboard.

38. The method of claim 23, wherein the plurality of keys are arranged as a calculator-style keypad.

39. The method of claim 23, further comprising:
formatting the electronic data representation.

40. The method of claim 23, further comprising:
converting coded shorthand into full text.

41. An article of manufacture comprising a tangible medium having stored thereon a plurality of instructions configured to be executed by a processor, which when executed cause the processor to perform the steps of claim 23.
